(19) United States
(12) Patent Application Publication
(10) Pub. No.: US 2006/0151644 A1
(43) Pub. Date: Jul. 13, 2006

(54) Dosing device for beneficial agents

(76) Inventors: Roy Smith, Naples, FL (US); Kon Smith, Naples, FL (US)

Correspondence Address: MCHALE & SLAVIN, P.A., 2855 PGA BLVD, PALM BEACH GARDENS, FL, 33410, US

(21) Appl. No.: 11/031,867

(22) Filed: Jan. 7, 2005

(51) Int. Cl. A47J 42/00

(52) U.S. Cl. 241/30; 241/169.1

(57) ABSTRACT

An electric hand-held dosing device has an ergonomically shaped handle with an electrical switch. A spring-loaded cap on the handle communicates with an internal hopper. A rotating grater blade is located in the hopper. The grater blade is connected to and rotated by a shaft powered by the power unit. The spring-loaded cap opens to allow for the insertion of a pill or tablet into the hopper. The spring-loading action of the door retains the pill within the hopper and forces the pill against the rotating grater blade. The pill particles exit through an outlet in the hopper. An impeller is mounted on the shaft and distributes the particles or mixes them with a carrier. In this manner, one hand operation of the dosing device is effected.

### RELATED FIELD

The present invention relates to a battery-operated hand-held pill pulverizer and mixer. More particularly, the invention relates to a hand-held solid pill pulverizer with one touch operation which automatically grates a solid pill or tablet made of or containing pharmaceutical compositions and mixes the beneficial agent with a liquid.

### BACKGROUND OF THE INVENTION

The delivery of vitamins, food supplements, and so forth to certain individuals or animals can be most problematic. For instance, small children, elderly, and individuals with enhanced sense of smell may dislike the scent of a pill. Simply breaking the pill in half may make it simpler to swallow but may otherwise offend the olfactory receptors in the nose.

For ease of discussion, reference is made to the expanding scope of veterinarian medicine which has introduced more and more treatments for the dogs, cats, birds, and other more exotic animals which are unable to voice their dislike of a medicine, large pill, or the scent carried therewith. Such animals are also known to have an enhanced scent of smell wherein, in addition to treating diseases, there are now other beneficial agents on the market for prevention of disease and conditions that such animals may could smell but are undetectable by a human.

Unfortunately, many animals resist, sometimes viciously, being forced to swallow or ingest these beneficial agents, in pill or tablet form. Since many such animals have a superior sense of smell as compared to a human, should the agent carry a distasteful scent, the animal may easily avoid the agent. In case of some animals, such as dogs and horses, it has been found that an agent such as a hardened medicament pill may be disguised in food. This may work if the pill is small enough to be swallowed, or the animal is willing to chew the pill. In many instances the pill cannot be effectively concealed wherein a hardened piece of material in the middle of soft food is instinctively an indication to the animal that the item may not be consumable. If the pill is simply broke in half, the rigid edges may lead to choking of the animal if the animal's throat is small enough wherein the rigid edges could engage the surfaces of the throat.

Simply crumbling of the hardened material may elimate the choking but the fact remains that most animal species that are taken as pets are more particular about their food and with their superior sense of smell can separate and ignore the agents, especially if they retain a mass such as a pill or tablet.

U.S. Pat. No. 5,376,072 to Klearman et al., discloses a pill grater and mixer using a hand operated syringe plunger to grate the pill against the interior of the barrel. The syringe is connected to a catheter for drawing liquid into the barrel and mixing the shreaded pill before injection.

Another hand-held pill grater is described in U.S. Pat. No. 5,148,995 to Hurst, which discloses a pill grating device comprising a body fitted with a hand operated rotating grinding wheel inside and a handle which has a hand operated pivotable plunger to force the pill against the grater. The ground particles exit through an outlet in the bottom of the body.

Marshall, U.S. Pat. No. 6,508,424, discloses an electrically operated pill grinder with a grinding plate rotating in the bottom of a hopper. The tablet is forced against the grinder by manually pushing on a plunger sliding in the hopper.

Bigelow, U.S. Pat. No. 5,364,037, discloses a hand-held electric cheese grater with a spring loaded door closing the grating compartment and holding the cheese to the grater. The grating compartment has an outlet for directing the grated cheese onto a substrate.

What is needed in the art is a device for reducing the beneficial agent to a size that minimizes the taste, look and presence of a beneficial agent and can be readily mixed with food or drink.

### SUMMARY OF THE INVENTION

It is therefore an objective of the present invention to provide an electric hand-held pill grater which can be easily operated with the push of a button and from which grated beneficial agents, including medicines, can be directed accurately towards a food substrate or into a mixing chamber for consumption by a human or an animal.

It is a further objective of the present invention to provide a pill grater in which a tablet can be easily inserted into and retained in a grating compartment, while being forced automatically and continuously against the grater mechanism.

It is another objective of the invention to provide a mixing impeller for stirring a liquid containing the grated medicine or spreading the grated medicine over the surface of a substrate.

It is a still further objective of the invention to provide a pill grater of simple construction which is safe to use and which has a minimum of moving parts.

Accordingly, there is provided an electric hand-held pill grater device with a hinged spring-loaded medication compartment door. The handle portion houses the power unit, which is activated by a button on the unit. The lower portion houses a grater blade in the form of a hollow cylinder residing within a coaxial exit tube. The grater blade is connected to and rotated by a shaft powered by the power unit. Also mounted on the shaft is an impeller for mixing or broadcasting grated particles. On the side of the lower portion is an opening to the grater compartment wherein a solid medication is placed against the grater blade. A spring-loaded cap opens to allow for the insertion of a tablet into the grater compartment. The spring-loading action of the cap retains the tablet within the grater compartment and forces the tablet against the rotating grater blade. In this manner, one handed operation of the grater is effected. Furthermore, the unique orientation of the various elements of the invention allows for a compact device which can be easily held in one hand and moved about with ease, so that during operation, the grated particles emerging from the exit tube can be directed accurately onto a food substrate or into a mixing chamber. Once the tablet has been completely grated, the spring action forces the cap into a resting, closed position.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a perspective view of the pill grater of the present invention;

FIG. 2 is a cross section of the pill grater of FIG. 1;

FIG. 3 is a top plan view of the pill grater of FIG. 1; and

FIG. 4 is a cross section of another embodiment of the pill grater of the present invention.

### DETAILED DESCRIPTION OF THE INVENTION

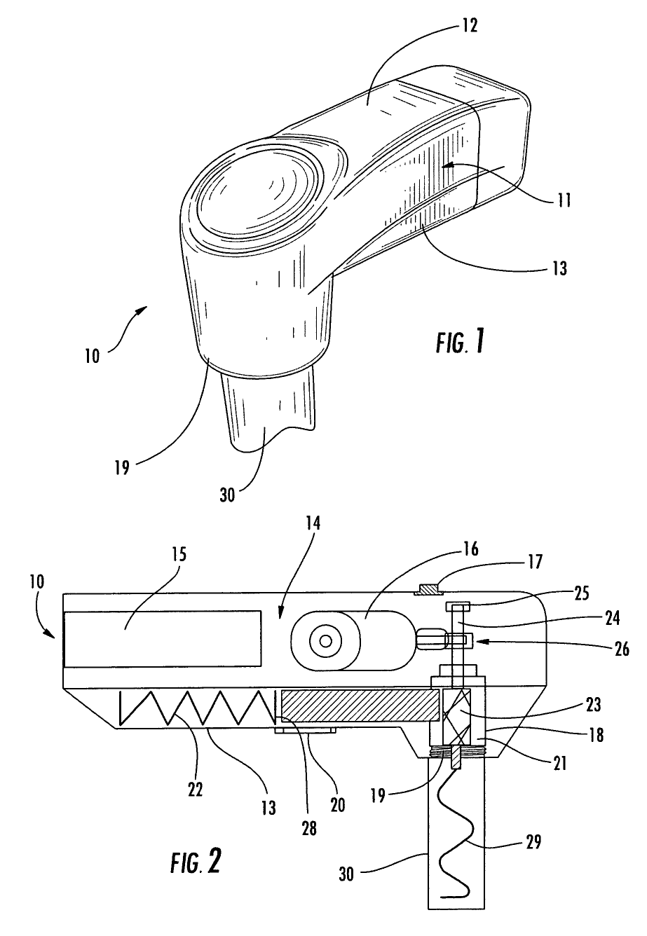

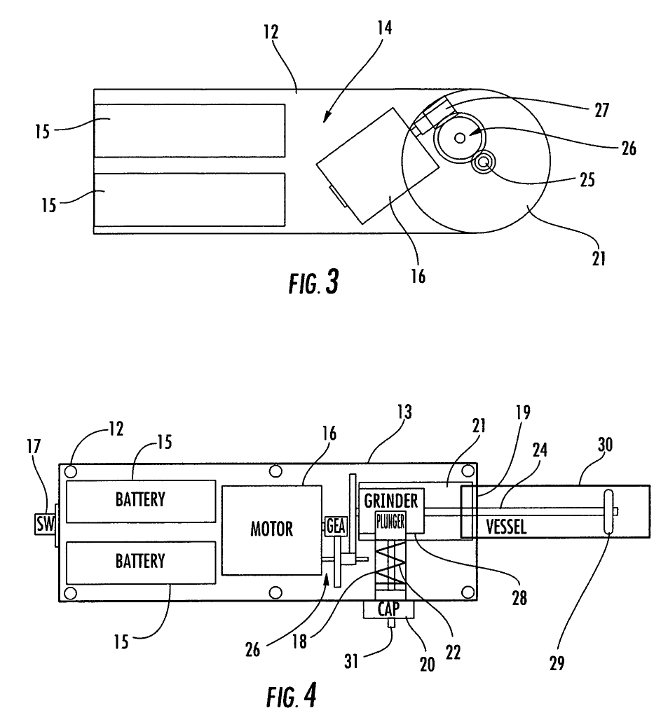

With reference to FIGS. 1-4, the grater 10 of the invention generally comprises a handle 11 having an upper portion 12 and a lower portion 13. The upper portion 12 houses therein a power unit 14, which may be a battery pack 15 or an electrical cord for operating an electric motor 16. The handle 11 preferably is ergonomically shaped in a elongated form which can easily be gripped by the hand of the operator. The upper portion 12 also has an actuator button 17 connected to the power unit 14 for setting the power unit into operation. The button 17 should be located such that it can easily be reached by the operator with the same hand that simultaneously grips the upper portion. In FIG. 2, the button 17 is shown on top of the upper portion however, it may be located on the lower portion 13 near the outlet.

The lower portion 13 comprises the grater housing 18 and a outlet 19 which extends outwardly from the grater housing 10 on one side thereof. The housing 18 has a sliding door 20, the outside of which is preferably flush with the outside of the lower compartment 13. By sliding the door 20 open, the interior of the pill hopper 21 is exposed for loading with a beneficial agent. The opening door compresses a spring 22 within the hopper permitting a beneficial agent to be placed in the hopper 21. Closing the door 20 releases the spring 22 to expand and force the beneficial agent toward the grater blade 23. The door 20 is biased by a spring 22 in the closing direction, i.e. towards the grater blade.

The grater housing 18 has a hollow cylindrical space defined by the grater housing inner wall which has an opening to the pill compartment. A cylindrical grater blade 23 is situated coaxially within the grater housing 18 for rotation therein. The blade may be solid or hollow. The grater blade 23 is connected to a vertical rotating shaft 24, which extends from and is rotated by the power unit 14. The shaft extends through the outlet 19 Preferably, the shaft 24 may have on its upper end a perpendicular locking nut 25. The shaft may have a conforming slot which receives the locking nut 25. The shaft is retained in the grater 10 by rotating the shaft 24 relative to the locking nut 25 until a locking position is reached. By turning the shaft in the opposite direction, the shaft and grater blade may be removed from the grater 10. In the grating operation, the shaft 24 is turned by the power train 26 which connects the output shaft 27 of the motor 16 with the locking nut 25.

The spring 22 has a plunger 28 shaped to conformingly reside within the 18 on all sides such that the door operates to plug the hopper during operation to prevent grated pill particles from emerging from the compartment. The plunger 28 has a concave cylindrical arc having a similar radius as the cylindrical grater blade, such that a pill placed between the plunger 28 and the grater blade 23 is grated to completion. As the beneficial agent diminishes in size during grating operation, the plunger 28 continues to push the remaining piece of pill against the rotating grater blade. As the pill gets smaller and smaller, the plunger 28 and the grater blade 23 approach a nesting orientation which insures that the pill will be completely grated.

In a preferred embodiment, shown in FIGS. 1-3, the shaft 24 is mounted perpendicularly to the longitudinal axis of the handle 11 and the motor 16. The locking nut 25 is at the top end, a drive gear is mounted below the locking nut in order to engage the output shaft of the electric motor as part of the power train 26, and an impeller 29 is secured to the lower end of the shaft. An extension 30 may be attached to the outlet 19 to act as a shroud about the impeller. The extension 30 may be open ended when used to stir the beneficial agent into a larger container of liquid or to broadcast the particles onto a substrate or carrier. The extension can also be a closed container for holding a measured amount of carrier to be dispensed after the beneficial agent has been integrated.

In the embodiment shown in FIG. 4, the shaft 24 is mounted in parallel with the motor 16. The cap 20 plugs the opening into the pill housing 18. A spring 22 is biased between the cap 20 and the plunger 28. A plunger stem 31 extends through the cap 20 and acts as a guide for the compression of the spring when pills are in the hopper.

The invention can be further defined as a method of dosing an animal or a human comprising the following steps;
a) providing the previously described hand held electric dosing device for mixing a beneficial agent with a carrier comprising a handle enclosing an electric power pack and a hopper for holding a beneficial agent, said hopper having an open outlet, said power pack operatively connected to one end of a shaft, said shaft extending through said hopper and said outlet, a grating wheel mounted on said shaft and rotating within said hopper, an impeller secured to the other end of said shaft for broadcasting said beneficial agent exiting said outlet;
b) providing a beneficial agent;
c) inserting said beneficial agent in said hopper into contact with said grating wheel;
d) electrically rotating said shaft, said grating wheel, and said impeller;
e) reducing said beneficial agent to separate particles;
f) distributing said particles into a carrier; and
g) administering said beneficial agent and carrier to a recipient.

It is to be understood that while I have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

1. A hand held electric dosing device for mixing a beneficial agent with a carrier comprising a handle enclosing an electric power pack and a hopper for holding a beneficial agent, said hopper having an open outlet, said power pack operatively connected to one end of a shaft, said shaft extending through said hopper and said outlet, a grating wheel mounted on said shaft and rotating within said hopper, an impeller secured to the other end of said shaft for broadcasting said beneficial agent exiting said outlet.

2. A hand held electric dosing device of claim 1 comprising a cap on said handle communicating with said hopper, said cap movable from one position closing said hopper and a second position opening said hopper for insertion of beneficial agent.

3. A hand held electric dosing device of claim 1 comprising a spring in said hopper, said spring having a plunger on one end, said spring biased to force said plunger toward said grating wheel, said spring extending between said cap and said grating wheel whereby the beneficial agent is moved toward said grating wheel.

4. A hand held electric dosing device of claim 1 comprising an extension connected to said outlet, said impeller rotating within said extension, said extension having an open end and acting as a guide for distributing said beneficial agent whereby said beneficial agent is deposited on a substrate or mixed with a liquid.

5. A hand held electric dosing device of claim 4 comprising said extension having a closed end for holding a liquid carrier, said impeller mixing said beneficial agent and said carrier.

6. A hand held electric dosing device for mixing a beneficial agent with a carrier comprising an ergonomically shaped handle enclosing an electric power pack and a hopper for holding a beneficial agent, a cap on said handle communicating with said hopper, said hopper having an open outlet, a switch on said handle operatively connected to said power pack, said power pack operatively connected to one end of a shaft, said shaft extending through said hopper and said outlet, a grating wheel mounted on said shaft and rotating within said hopper, a spring in said hopper between said cap and said grating wheel, said spring biased toward said grating wheel, a plunger between said spring and said grating wheel for contacting said beneficial agent and forcing said beneficial agent toward said grating wheel, and an impeller secured to the other end of said shaft for broadcasting said beneficial agent exiting said outlet.

7. A method of dosing a recipient comprising the following steps;
a) providing a hand held electric dosing device for mixing a beneficial agent with a carrier comprising a handle enclosing an electric power pack and a hopper for holding a beneficial agent, said hopper having an open outlet, said power pack operatively connected to one end of a shaft, said shaft extending through said hopper and said outlet, a grating wheel mounted on said shaft and rotating within said hopper, an impeller secured to the other end of said shaft for broadcasting said beneficial agent exiting said outlet;
b) providing a beneficial agent;
c) inserting said beneficial agent in said hopper into contact with said grating wheel;
d) electrically rotating said shaft, said grating wheel, and said impeller;
e) reducing said beneficial agent to separate particles;
f) distributing said particles into a carrier; and
g) administering said beneficial agent and carrier to a recipient.
